(19) United States
(12) Patent Application Publication
(10) Pub. No.: US 2018/0307043 A1
(43) Pub. Date: Oct. 25, 2018

(54) HEAD-MOUNTED DISPLAY DEVICE

(71) Applicant: SHENZHEN ROYOLE TECHNOLOGIES CO. LTD., Shenzhen, Guangdong (CN)

(72) Inventor: Hongyan SHI, Shenzhen, Guangdong (CN)

(21) Appl. No.: 15/768,680

(22) PCT Filed: Dec. 30, 2015
(86) PCT No.: PCT/CN2015/099873

§ 371 Date: Apr. 16, 2018

(51) Int. Cl. G02B 27/01; G02C 7/08; G02C 5/04

(52) U.S. Cl. CPC G02B 27/0172; G02C 7/08; G02B 2027/011; G02B 2027/0178; G02C 5/04

(57) ABSTRACT

A head-mounted display device includes a housing, and a display, a focusing assembly which are disposed inside the housing. The housing includes a pair of spaced viewing windows. The focusing assembly includes a pair of liquid lenses disposed corresponding to the viewing windows respectively. Each of the liquid lenses includes a transmissive component including a casing within which a liquid cavity is formed. The case includes an elastic membrane disposed opposite to a corresponding viewing window. Each of the liquid lenses further includes a liquid storing component and a liquid driving component. A liquid storing chamber is formed within liquid storing component. The liquid cavity and the liquid storing cavity are intercommunicated by an intercommunicating pipe. The liquid driving component is operable to drive liquid in the liquid lens to flow between the liquid cavity and the liquid storing chamber, such that the elastic membrane becomes convex, planar or concave.

### RELATED APPLICATIONS

The present application is a National Phase of International Application Number PCT/CN2015/099873, filed Dec. 30, 2015.

### TECHNICAL FIELD

The present disclosure relates to display technologies, and in particular, to a head-mounted display device.

### BACKGROUND

Conventional head-mounted display devices are usually designed according to normal eyes of most users. Hence, if a user has a diopter problem such as myopia or hyperopia, images displayed on a display screen in the head-mounted display device cannot be directly and clearly projected onto the user's retina, i.e., the images displayed in the head-mounted display device may not be clearly viewed by the user. In order to solve this problem, two solutions as follows are generally adopted in related art: 1, the user views after wearing glasses and then wearing the head-mounted display device; 2, an optical display system in the head-mounted display device is redesigned, and the head-mounted display device has a limited focusing range by altering a focal length or a distance from a lens to a display screen.

However, in solution 1, the glasses increase pressure on the bridge of the nose and the user will obviously feel uncomfortable. Furthermore, most of the conventional head-mounted display devices are immersive ones, that is to say, display assembly thereof constructs a fully enclosed imaging environment. If the user views after wearing the glasses, outside light may be easily leak into the imaging environment, thereby directly reducing display quality of the display assembly. In solution 2, since the optical display system in the head-mounted display device is generally extremely precisely designed, modifications to the design is extremely difficult. Furthermore, even if the modifications are made to the design, the head-mounted display device easily has a more complex structure, an increased size, which in turn restricts a range of diopter adjustment such that requirements of the user may not be met. Therefore, applications of the head-mounted display devices are greatly restricted, unless the above-mentioned problems can be solved.

### SUMMARY

A head-mounted display device having broad applicability is provided by the implementations of the present disclosure.

In order to achieve the purpose, a head-mounted display device is provided by the implementations of the present disclosure. The head-mounted display device includes a housing, a display, an optical assembly, and a focusing assembly. The display, the optical assembly, and the focusing assembly are disposed inside the housing. The housing includes a pair of spaced viewing windows. The focusing assembly includes a pair of liquid lenses disposed corresponding to the viewing windows, respectively.

Each of the liquid lenses includes a transmissive component including a casing within which a liquid cavity is formed. The case includes an elastic membrane disposed opposite to the viewing window. A display light source provided by the display is transmitted in the direction of exit pupils after sequentially passing through the optical assembly and the elastic membrane.

Each of the liquid lenses further includes a liquid storing component and a liquid driving component. A liquid storing chamber is formed within the liquid storing component. The liquid cavity and the liquid storing chamber are intercommunicated by an intercommunicating pipe. The liquid driving component drives liquid in the liquid lens to flow between the liquid cavity and the liquid storing chamber, such that the elastic membrane becomes convex, planar, or concave.

Compared with the related art, in the head-mounted display device according to the implementations of the present disclosure, the liquid is driven by the liquid driving component to flow between the liquid cavity and the liquid storing chamber, such that the elastic membrane becomes convex, planar or concave, and the transmissive component forms a convex lens, a planar lens or a concave lens correspondingly. After the light emitted by the display light source passes through the optical assembly and the elastic membrane (i.e., after passing through the transmissive component), the focal length of the light is reduced, unchanged, or increased, such that not only viewing requirements of a user with normal eyes are met, but also a technical problem that a user having a diopter problem (such as myopia or hyperopia) may not clearly view images displayed in the head-mounted display device is solved. Hence, the head-mounted display device according to the implementations may be suitable for most users, and has broad applicability. In addition, compared with the related art, the head-mounted display device according to the implementations does not need the optical assembly in the housing to be redesigned, thereby avoiding a waste of space in the head-mounted display device and an increase in cost.

### BRIEF DESCRIPTION OF THE DRAWINGS

In order to more clearly describe technical solutions in implementations of the present disclosure and the prior art, accompanying drawings used for describing the implementations will be briefly introduced hereinafter. Apparently, the accompanying drawings described hereinafter merely show some implementations of the present disclosure, and persons skilled in the art may also derive other drawings from these accompanying drawings without creative efforts.

FIG. 1 is a schematic structural view of a head-mounted display device according to an implementation of the present disclosure.

FIG. 2 is another schematic structural view of a head-mounted display device according to an implementation of the present disclosure.

FIG. 3 is a schematic structural view of a liquid lens of a head-mounted display device according to an implementation of the present disclosure.

FIG. 4 is another schematic structural view of the liquid lens as illustrated in FIG. 3.

FIG. 5 is yet another schematic structural view of the liquid lens as illustrated in FIG. 3.

FIG. 6 is a schematic structural view of a transmissive component of a liquid lens of a head-mounted display device according to an implementation of the present disclosure.

FIG. 7 is a schematic structural view of a distance-adjusting means of a head-mounted display device according to an implementation of the present disclosure.

FIG. 8 is another schematic structural view of the distance-adjusting means as illustrated in FIG. 7.

FIG. 9 is a schematic structural view of another distance-adjusting means of a head-mounted display device according to an implementation of the present disclosure.

### DETAILED DESCRIPTION

A clear, complete description for technical solutions in implementations of the present disclosure is provided below, in conjunction with the drawings in the implementations of the present disclosure. Apparently, the implementations described herein are a part, rather than all of the implementations of the present disclosure. Other implementations obtained by persons skilled in the art from the implementations given herein without creative efforts should all fall within the protection scope of the present disclosure.

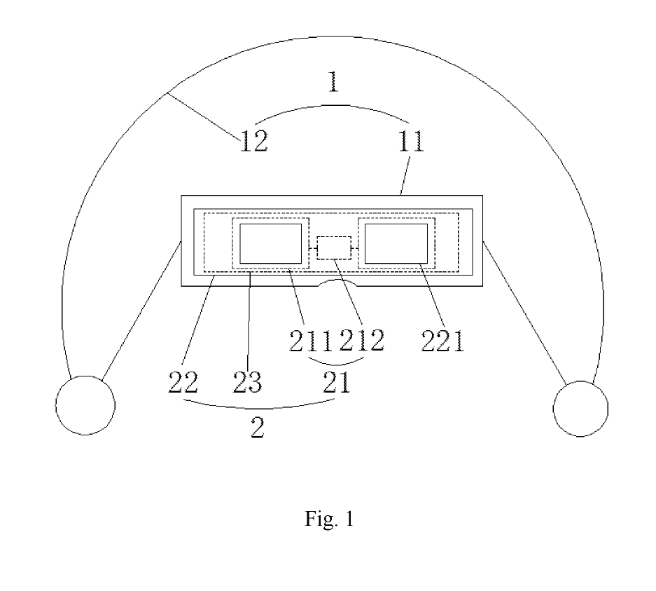

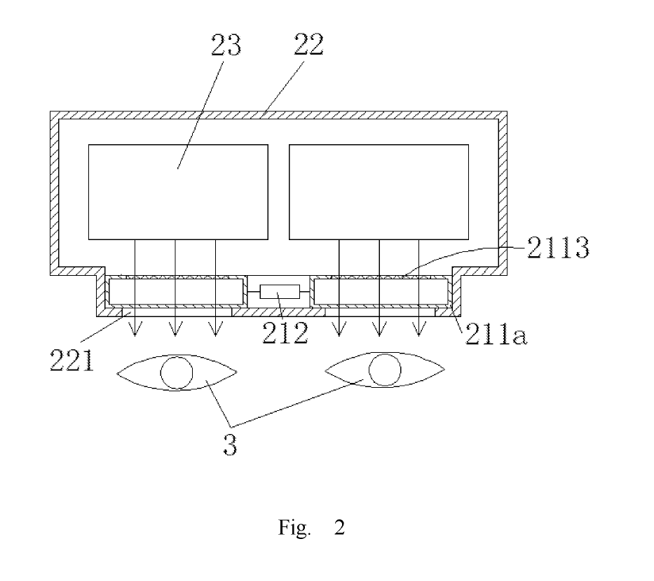

Referring to FIG. 1 to FIG. 5, a head-mounted display device is provided by an implementation of the present disclosure. Specifically, in the implementation of the present disclosure, an immersive display device is described as an example. The head-mounted display device includes a housing 22, an optical assembly 23, and a focusing assembly 21. The optical assembly 23 and the focusing assembly 21 are disposed inside the housing 22. The housing 22 includes a pair of spaced viewing windows 221. The focusing assembly 21 includes a pair of liquid lenses 211 disposed corresponding to the viewing windows 221, respectively. The liquid lenses 211 are filled with liquid. Each of the liquid lenses 211 includes a transmissive component 211a. The transmissive component 211a includes a casing 2115. A liquid cavity 211a′ is formed within the casing 2115. The casing 2115 includes an elastic membrane 2113 disposed opposite to the corresponding viewing window 221. As illustrated in FIG. 2, arrows represent light, and a display of the head-mounted display device provides a display light source. Light emitted by the display light source through the optical assembly 23 is transmitted in the direction of exit pupils after passing through the elastic membrane 2113. It should be understood that, when a user wears the head-mounted display device, the user's eyes 3 are opposite to the optical exit pupils of the head-mounted display device, that is to say, the light emitted by the display light source is transmitted to the user's eyes 3. In order to illustrate the solutions of the present disclosure, the exit pupils are represented by the user's eyes 3.

In this implementation, each of the liquid lenses 211 further includes a liquid storing component 211c and a liquid driving component 211d. A liquid storing chamber 211c′ is formed within the liquid storing component 211c. The liquid cavity 211a′ and the liquid storing chamber 211c′ are intercommunicated by an intercommunicating pipe 211b. The liquid driving component 211d is configured to drive the liquid in the liquid lens 211 to flow between the liquid cavity 211a′ and the liquid storing chamber 211c′, such that the elastic membrane 2113 becomes convex, planar, or concave.

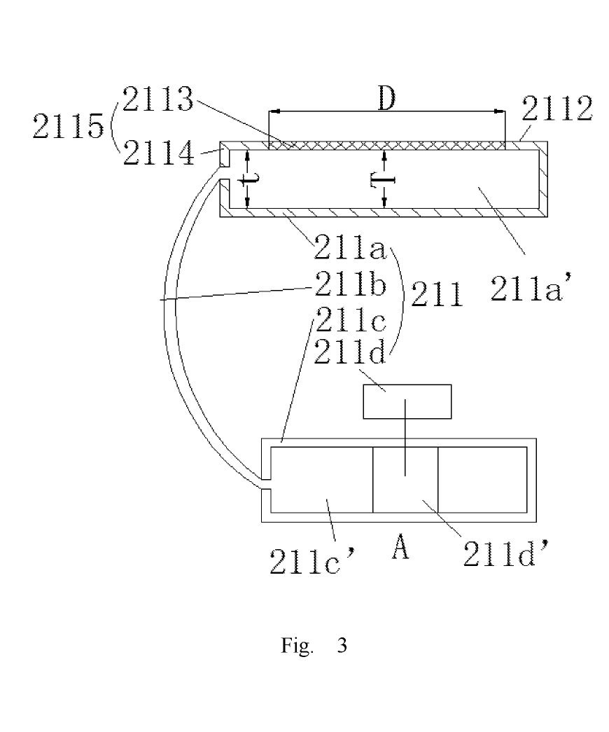

For example, referring to FIG. 3 to FIG. 5, the edge of the liquid cavity 211a′ has a first thickness t, while the middle of the liquid cavity 211a′ has a second thickness T. Furthermore, a liquid storing cylinder is adopted as the liquid storing component 211c, and the liquid driving component 211d includes a piston 211d′ disposed in the liquid storing cylinder. The liquid driving component 211d is connected to and drives the piston 211d′ via a connecting rod.

Specifically, as illustrated in FIG. 3, when the piston 211d′ of the liquid driving component 211d is at an initial position A, the elastic membrane 2113 becomes planar, the second thickness T is equal to the first thickness t, and the transmissive component 211a forms a planar lens. After the light transmitted through the optical assembly 23 passes through the elastic membrane 2113 (i.e., after passing through the transmissive component 211a), the focal length of the light is unchanged, such that the head-mounted display device is suitable for a user with normal eyes.

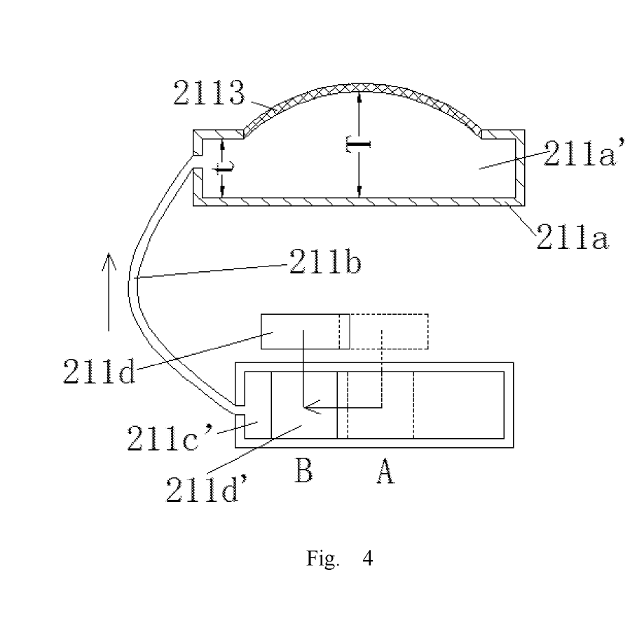

As illustrated in FIG. 4, when the liquid driving component 211d drives the piston 211d′ to move from the position A to an position B, the piston 211d′ extrudes the liquid in the liquid storing cylinder, such that the liquid flows from the liquid storing chamber 211c′ to the liquid cavity 211a′ via the intercommunicating pipe 211b. Liquid pressure in the liquid cavity 211a′ becomes greater than the atmospheric pressure, such that the elastic membrane 2113 is tensioned outward. The elastic membrane 2113 becomes convex, the second thickness T is greater than the first thickness t, and the transmissive component 211a forms a convex lens. After the light transmitted through the optical assembly 23 passes through the elastic membrane 2113 (i.e., after passing through the transmissive component 211a), the focal length of the light is reduced, such that the head-mounted display device is suitable for a hyperopic user.

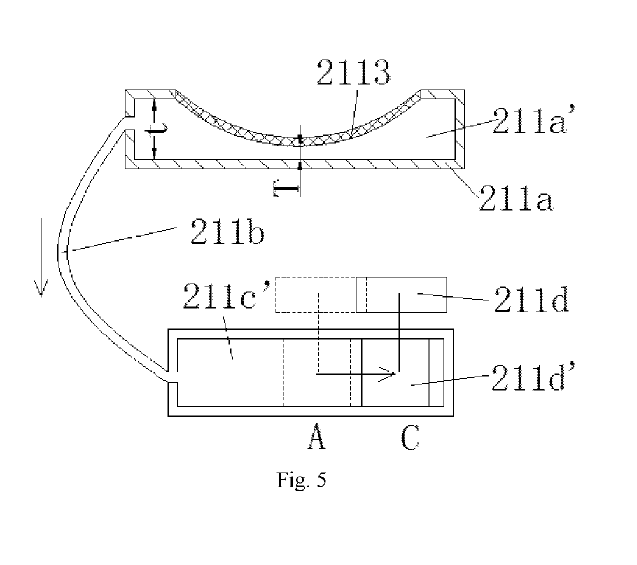

As illustrated in FIG. 5, when the liquid driving component 211d drives the piston 211d′ to move from the position A to an position C, the piston 211d′ sucks the liquid in the liquid cavity 211a′, such that the liquid flows from the liquid cavity 211a′ to the liquid storing chamber 211c′ through the intercommunicating pipe 211b. The liquid pressure in the liquid cavity 211a′ is less than the atmospheric pressure which presses the elastic membrane 2113 inward. The elastic membrane 2113 becomes concave, the second thickness T is less than the first thickness t, and the transmissive component 211a forms a concave lens. After the light transmitted through the optical assembly 23 passes through the elastic membrane 2113 (i.e., after passing through the transmissive component 211a), the focal length of the light is increased, such that the head-mounted display device is suitable for a myopic user.

As described above, in the head-mounted display device according to this implementation, the liquid is driven by the liquid driving component 211d to flow between the liquid cavity 211a′ and the liquid storing chamber 211c′, such that the elastic membrane becomes convex, planar or concave, and the transmissive component 211a forms the convex lens, the planar lens or the concave lens correspondingly. After the light emitted by the display light source through the optical assembly 23 passes through the elastic membrane 2113 (i.e., after passing through the transmissive component 211a), the focal length of the light is reduced, unchanged, or increased, such that not only the viewing requirements of the user with normal eyes are met, but also the technical problem that a user having a diopter problem (such as myopia or hyperopia) may not clearly view images displayed in the head-mounted display device is solved. Hence, the head-mounted display device according to this implementation may be suitable for most users, and has broad applicability. In addition, compared with the related art, the head-mounted display device according to this implementation does not need the optical assembly 23 in the housing 22 to be modified, for example, adjusting the diopter by changing a distance between the display and the optical assembly 23, thereby avoiding an increase in the size of the head-mounted display device resulting from distance adjustment.

Naturally, in another implementation of the present disclosure, the liquid cavity 211a′ may be directly connected to an air pump via the intercommunicating pipe. The air pump pumps gas into or out of the liquid cavity 211a′ to change pressure difference between the inside and outside of the liquid cavity 211a′, so as to control the convexity or concavity of the elastic membrane 2113.

Alternatively, in yet another implementation of the present disclosure, the liquid cavity 211a′ is filled with liquid and gas together. At this time, when the temperature in the liquid cavity 211a′ is increased, the gas in the liquid cavity 211a′ expands and the pressure is heightened, thereby rendering the elastic membrane 2113 convex. When the temperature in the liquid cavity 211a′ is reduced, the gas in the liquid cavity 211a′ contracts and the pressure is lowered, thereby rendering the elastic membrane 2113 concave. In other words, the elastic membrane 2113 has a shape which can be flexibly controlled by controlling the temperature in the liquid cavity 211a′.

Furthermore, referring to FIG. 3 to FIG. 5, the elastic membrane 2113 has a diameter D when the pressure inside and outside the liquid cavity 211a′ is equal. When the elastic membrane 2113 is convex or concave, the second thickness T is changed by ΔT=|T−t|≤D/2, that is to say, the elastic membrane 2113 is hemispherically convex or concave at most under the effect of the internal and external pressure, so as to maintain a high-quality light focusing effect, thereby preventing the display quality of the head-mounted display device from being affected by excessive deformation.

Furthermore, the second thickness T is changed by ΔT=|T−t|≥t/4, preferably ΔT≥t/2. The transmissive component 211a varying in the aforementioned range has the best light focusing effect.

In a preferred implementation of the present disclosure, referring to FIG. 2 and FIG. 3, the casing 2115 includes a first surface 2112 facing away from the corresponding viewing window 221. The elastic membrane 2113 is disposed in the central area of the first surface 2112. Furthermore, the casing 2115 further includes a rigid transparent frame 2114, and the elastic membrane 2113 and the transparent frame 2114 are interconnected and together enclose the liquid cavity 211a′. In this implementation, the rigid transparent frame 2114 is not deformed, and hence the user's eyes can be closer to the viewing window 221 by far, so as to reduce a risk that outside light might affect the visual effect and ensure high-quality display of the head-mounted display device. Naturally, the rigid transparent frame 2114 is not deformed during focusing of the transmissive component 211a, thereby ensuring accuracy of the focusing of the transmissive component 211a.

It should be understood that, in this implementation, both the elastic membrane 2113 and the rigid transparent frame 2114 are made of material that does not change the direction of the light transmission. The elastic membrane 2113 has a structure which is not necessarily limited to a laminated one and can be any structure having a certain degree of elastic deformation. The elastic membrane 2113 and the rigid transparent frame 2114 may form the housing 2115 by assembling or integrally molding.

Furthermore, the area s of the elastic membrane 2113 and the area S of the first surface 2112 meet a relational expression: s≥½*S, preferably s≥⅔*S, and more preferably s=S. At this time, the transmissive component 211a has the best focusing range.

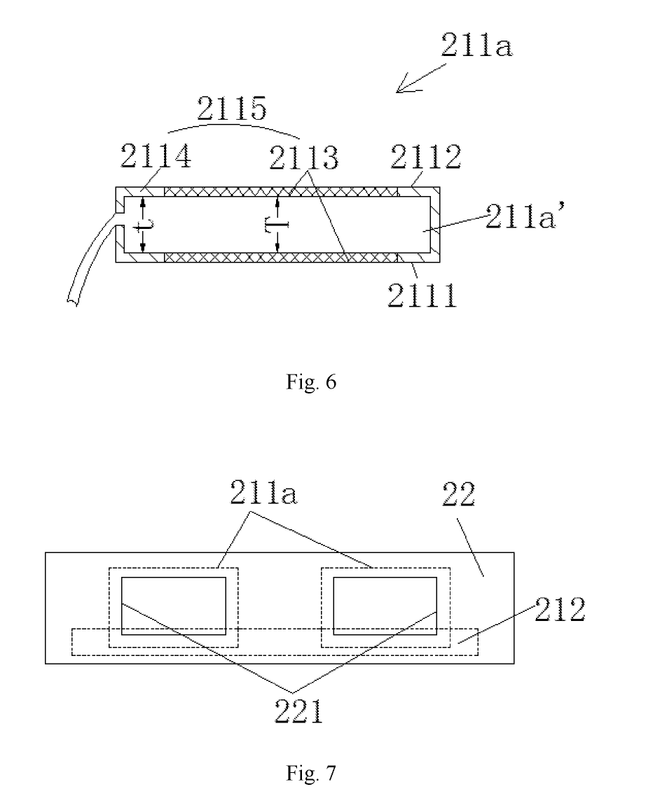

In another preferred implementation of the present disclosure, referring to FIG. 6, the casing 2115 includes a first surface 2112 and a second surface 2111 disposed opposite to each other. The first surface 2112 faces away from the corresponding viewing window 221, while the second surface 2111 faces towards the corresponding viewing window 221. The elastic membrane 2113 includes a first elastic membrane and a second elastic membrane. The first elastic membrane and the second elastic membrane are disposed in the first surface 2112 and the second surface 2111, respectively. Furthermore, the casing 2115 further includes the rigid transparent frame 2114, and the elastic membrane 2113 and the transparent frame 2114 are interconnected and together enclose the liquid cavity 211a′.

In this implementation, the rigid transparent frame 2114 is not deformed, and hence the user's eyes can be closer to the viewing window by far, so as to reduce the risk that the outside light might affect the visual effect and ensure the high-quality display of the head-mounted display device. Moreover, although a portion of space in the head-mounted display device is additionally occupied in this implementation, the transmissive component 211a has a wider focusing range and the head-mounted display device is suitable for more users.

Furthermore, the area of the first elastic membrane is greater than or equal to one-second of that of the first surface 2112. Preferably, the area of the first elastic membrane is greater than or equal to two-thirds of that of the first surface 2112. Most preferably, the area of the first elastic membrane is equal to that of the first surface 2112. Furthermore, the area of the second elastic membrane is greater than or equal to one-second of that of the second surface 2111. Preferably, the area of the second membrane is greater than or equal to two-thirds of that of the second surface 2111. Most preferably, the area of the second elastic membrane is equal to that of the second surface 2111. At this time, the transmissive component 211a has the best focusing range.

It should be understood that, in the above implementation, the transmissive component 211a is disposed in the housing 22, and hence the head-mounted display device has a neat and beautiful appearance. However, the present disclosure also intends to claim a solution in which the transmissive component 211a is disposed out of the housing 22. In this solution, the transmissive component 211a is detachably disposed near the view window 211 so as to be located in the transmission path of the light from the display light source. Since the transmissive component 211a is detachable, the transmissive component 211a, when unnecessary, can be detached from the head-mounted display device, so as to reduce the weight of the head-mounted display device.

Furthermore, the liquid in each of the liquid lenses 211 has a refractive index greater than 1. The greater the refractive index of the liquid is, the wider focusing range (i.e., a wider range of diopter adjustment) the liquid lens 211 has under the same adjustment. In this implementation, the liquid is preferably at least one selected from a group consisting of carbon disulfide, benzene and oil, that is to say, the liquid may be a single liquid component or a combination of multiple liquid components.

Furthermore, the intercommunicating pipe 211b may include a first intercommunicating pipe and a second intercommunicating pipe. In this case, the liquid storing chamber 211c′ may include a first liquid storing chamber and a second liquid storing chamber. The first liquid storing chamber is connected to one end of the liquid cavity via the first intercommunicating pipe, while the second liquid storing chamber is connected to the other end of the liquid cavity 211a′ via the second intercommunicating pipe. That is to say, the two liquid storing chambers are disposed and connected to the two ends of the liquid cavity 211a′ via different intercommunicating pipes, such that amount of the liquid received in the liquid cavity 211a′ can be adjusted more flexibly. For example, the first intercommunicating pipe may be an input pipe, the second intercommunicating pipe may be an output pipe, and the liquid is configured to be input only from one end of the liquid cavity 211a′ and output from the other end thereof to independently control the flow of the liquid in the liquid cavity 211a′ such that the elastic membrane 2113 changes more sensitively. Naturally, the first communicating pipe and the second communicating pipe may both be configured to function as input pipes or the output pipes, and the entry or exit of the liquid at the two ends of the liquid cavity 211a′ may be adjusted simultaneously such that the elastic membrane 2113 changes more rapidly.

It should be understood that, referring to FIG. 2, in this implementation, a distance between a pair of viewing windows 221 is generally set equal to or substantially equal to the user's interpupillary distance so as to make it convenient for the user to view. In the meantime, preferably, the transmissive components 211a of the focusing assembly 21 cover the viewing windows 221 respectively, such that light transmitted from the viewing windows 221 can be transmitted into the user's eyes 3 via the transmissive components 211a, so as to provide normal displayed images for the user. Preferably, the transmissive components 211a are in close contact with the viewing windows 221 respectively so as to prevent the outside light from being transmitted into the transmission path of the light of the head-mounted display device 23 from a gap between the transmissive components 211a and the viewing windows 221 to degrade the display effect of the head-mounted display device. When the head-mounted display device is an immersive display device, the close contact is more important. Naturally, when the transmissive components 211a are spaced from the viewing windows 221 respectively, a light-blocking component may be additionally disposed to block the outside light.

Furthermore, referring to FIG. 1 and FIG. 2, the focusing assembly 21 further includes a distance-adjusting means 212 to adjust a distance between the transmissive components 211a of the pair of liquid lenses 211 to render a distance between the centers of the elastic membranes 2113 of the pair of liquid lenses 211 equal to the user's interpupillary distance. In other words, the centers of the elastic membranes 2113 can just opposite to the user's eyes 3 such that the light transmitted onto the user's eyes 3 can be best corrected, thereby achieving the high-quality display in the head-mounted display device.

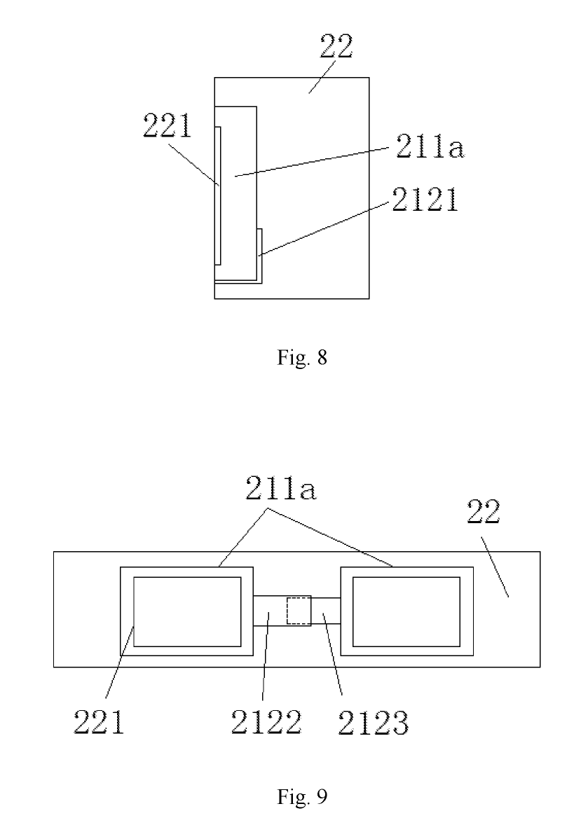

As a preferable implementation of the present disclosure, referring to FIG. 2, FIG. 7 and FIG. 8, the distance-adjusting means 212 includes a groove 2121 disposed in the housing 22. A rail in the groove 2121 extends from one viewing window 221 to the other viewing window 221, and the pair of transmissive components 211a is slidably disposed in the groove 2121. In this implementation, the pair of transmissive components 211a can move freely along the rail in the groove 2121 and can be manually or electrically controlled to enable the distance-adjusting means 212 to adjust the distance between the transmissive components 211a.

As another preferable implementation of the present disclosure, referring to FIG. 2 and FIG. 9, the distance-adjusting means 212 includes a first rod 2122 and a second rod 2123 which are screwed together. The first rod 2122 and the second rod 2123 are connected to the pair of transmissive components 211a respectively. In this implementation, the first rod 2122 and the second rod 2123, which are screwed together, can move relative to each other, and in turn drives the pair of transmissive components 211a to move relative to each other to enable the distance-adjusting means 212 to adjust the distance between the transmissive components 211a.

It should be understood that, the above two preferable implementations may be independent of each other, or combined with each other to achieve a new solution, that is, the distance-adjusting means may include the groove as well as the first and second rods which are screwed together. The groove is configured to provide a rail (moving path) for the pair of transmissive components 211a, while the first and second rods are configured to precisely adjust the distance between the pair of transmissive components 211a.

Furthermore, referring to FIG. 2 and FIG. 3, in order to facilitate enabling the centers of the elastic membranes 2113 to be just opposite to the user's eyes 3, the centers of the elastic membranes 2113 are configured to coincide with the centers of the transmissive components 211a. In this way, the distance-adjusting means 212 merely needs to adjust the distance between the centers of the two transmissive components 211a. It should be understood that the distance-adjusting means 212 may have various implementations, and any structure capable of adjusting the distance is within the protection scope of the present disclosure. The distance-adjusting means 212 includes, but is not limited to, a lead screw structure, a screw rod structure, and a gear structure.

Furthermore, referring to FIG. 1 and FIG. 3, the head-mounted display device further includes a fixing assembly 1 which includes a first bracket 11 and a second bracket 12. The first bracket 11 is mounted on the user's face (usually the vicinity of the eyes and the bridge of the nose), while the second bracket 12 is mounted on the user's head. The housing 22 is fixed to the first bracket 11 so as to make it convenient for the user's eyes to directly view the light emitted by the optical assembly 23. The transmissive component 211a of each of the liquid lenses 211 is fixed to the housing 22, that is to say, the transmissive component 211a is fixed to the first bracket 11. In the meantime, the liquid storing component 211c and the liquid driving component 211d of the each liquid lens 211 are fixed to the second bracket 12.

In this implementation, the first bracket 11 is usually mounted on the bridge of the user's nose, and the second bracket 12 can be mounted on the user's head. Hence, if the first bracket 11 supports too many components, the user may feel pressure and uncomfortability on the bridge of his/her nose. In the head-mounted display device of this implementation, the transmissive components 211a of the liquid lenses 211 are fixed to the first bracket 11, that is to say, the transmissive components 211a are fixed to the first bracket 11, while the liquid storing components 211c and the liquid driving components 211d of the liquid lenses 211 are fixed to the second bracket 12. The different components of the liquid lenses 211 are separately disposed, and hence the load on the first bracket 11 is reduced, and in turn the burden on the bridge of the user's nose is reduced, such that the user has a better experience. Naturally, the head-mounted display device of the present disclosure may further include an audio assembly which is fixed to the second bracket 12. The second bracket 12 includes an enclosing earphone and a top fixing sub-bracket which can be used for fixing and supporting.

The implementations of the present disclosure are described in detail hereinbefore. The principles and implementations of the present disclosure are set forth by way of specific examples herein. The description of the aforementioned implementations is merely for assisting in understanding the methods and spirits of the present disclosure. Meanwhile, based on the spirits of the present disclosure, persons skilled in the art can make modifications to the implementations and application scope. In conclusion, the content of the present disclosure should not be considered as a limitation on the present disclosure.

What is claimed is:

1. A head-mounted display device, comprising a housing, a display, and a focusing assembly, wherein the display, and the focusing assembly are disposed inside the housing, the housing comprises a pair of spaced viewing windows, the focusing assembly comprises a pair of liquid lenses disposed corresponding to the viewing windows, respectively;
each of the liquid lenses comprising a transmissive component comprising a casing within which a liquid cavity is formed, wherein the case comprises an elastic membrane disposed opposite to a corresponding viewing window, light provided by the display is transmitted in the direction of exit pupils after passing through the elastic membrane; and
each of the liquid lenses further comprising a liquid storing component and a liquid driving component, wherein a liquid storing chamber is formed within the liquid storing component, the liquid cavity and the liquid storing chamber are intercommunicated by an intercommunicating pipe, the liquid driving component is operable to drive liquid in the liquid lens to flow between the liquid cavity and the liquid storing chamber, such that the elastic membrane becomes convex, planar, or concave.

2. The head-mounted display device of claim 1, wherein the casing comprises a first surface facing away from the corresponding viewing window, and the elastic membrane is disposed in a central area of the first surface.

3. The head-mounted display device of claim 1, wherein the casing comprises a first surface and a second surface disposed opposite to each other, the first surface faces away from the corresponding viewing window, the second surface is adjacent to the corresponding viewing window, the elastic membrane comprises a first elastic membrane and a second elastic membrane, and the first elastic membrane and the second elastic membrane are disposed in the first surface and the second surface, respectively.

4. The head-mounted display device of claim 2, wherein
the casing further comprises a rigid transparent frame, the elastic membrane and the rigid transparent frame are interconnected and together encloses the liquid cavity.

5. The head-mounted display device of claim 1, wherein the liquid in each of the liquid lenses has a refractive index greater than 1.

6. The head-mounted display device of claim 1, wherein the intercommunicating pipe comprises a first intercommunicating pipe and a second intercommunicating pipe, the liquid storing chamber comprises a first liquid storing chamber and a second liquid storing chamber, the first liquid storing chamber is connected to one end of the liquid cavity via the first intercommunicating pipe, and the second liquid storing chamber is connected to the other end of the liquid cavity via the second intercommunicating pipe.

7. The head-mounted display device of claim 1, wherein the focusing assembly further comprises a distance-adjusting means to adjust a distance between the pair of the transmissive components to render a distance between centers of the pair of the elastic membranes equal to a user's interpupillary distance.

8. The head-mounted display device of claim 7, wherein the distance-adjusting means comprises a groove disposed in the housing, a rail in the groove extends from one viewing window to the other viewing window, and the transmissive components are slidably disposed in the groove.

9. The head-mounted display device of claim 7, wherein the distance-adjusting means comprises a first rod and a second rod which are screwed together, and the first rod and the second rod are connected to the pair of transmissive components respectively.

10. The head-mounted display device of claim 1, wherein the head-mounted display device further comprises a first bracket mounted on a user's face and a second bracket mounted on the user's head, the housing is fixed to the first bracket, the transmissive component of each of the liquid lenses is fixed to the housing, and the liquid storing component and the liquid driving component of each of the liquid lenses are fixed to the second bracket.

11. The head-mounted display device of claim 3, wherein the casing further comprises a rigid transparent frame, the elastic membrane and the rigid transparent frame are interconnected and together encloses the liquid cavity.

12. The head-mounted display device of claim 1, further comprising an optical assembly, wherein the optical assembly is disposed inside the housing, and the light provided by the display is transmitted in the direction of exit pupils after sequentially passing through the optical assembly and the elastic membrane.
